(19) United States
(12) Patent Application Publication
(10) Pub. No.: US 2005/0268673 A1
(43) Pub. Date: Dec. 8, 2005

(54) Device and method for protecting a computer peripheral against unauthorized removal

(75) Inventors: Willem Hendrik Bakker, Almere, VP (NL); Jan Willem Elkhuizen, Leewarden (NL); Hendrik Gerrit Blom, Den Hang (NL)

Correspondence Address: MERCHANT & GOULD PC, P.O. BOX 2903, MINNEAPOLIS, MN, 55402-0903, US

(73) Assignee: BAKKER & ELKHUIZEN HOLDING B.V., Almere, VP (NL)

(21) Appl. No.: 10/515,676

(22) PCT Filed: May 21, 2002
(86) PCT No.: PCT/NL02/00319

§ 371 Date: Jun. 15, 2005

(51) Int. Cl. E05B 69/00

(52) U.S. Cl. 70/58

(57) ABSTRACT

A device for protecting a computer peripheral against unauthorized removal includes a signal cord-holding portion (23; 84, 85; 173) having a signal cord holding passage (26; 76, 126). The signal cord holding portion (23; 84, 85; 173) is transformable between an open condition for receiving the signal cord (11, 12; 111, 112) in the signal cord holding passage (26; 76, 126; 176) or releasing the signal cord (11, 12; 111, 112) and a signal cord holding condition for preventing removal of the signal cord (11, 12; 111, 112) without dismounting from a connector or peripheral (9, 10, 27, 28; 127, 128). A connecting structure (25; 75; 142, 143; 175) is provided for connecting the device to an object. The signal cord holding portion (23; 84, 85) and the connecting structure (25; 75) are interconnected for securing the signal cord holding portion (23; 84, 85) in the signal cord holding condition if the connecting structure (25; 75; 142, 143; 175) is connected to an object (2; 30). A device for protecting a computer peripheral against unauthorized removal is also described.

### TECHNICAL FIELD AND BACKGROUND ART

The invention relates to a device and method for protecting a computer peripheral against unauthorized removal.

It is quite usual to protect computer equipment against unauthorized removal. For instance, for protecting notebook computers from theft, the use of cable locks—an end of wire with a loop and a lock for engaging a slot in the housing of the computer—with which the computer can be secured to a structure or item which is fixed to the building or difficult to carry (such as a piece of furniture or an eye connected to a wall) is quite usual.

However, this does not protect the computer peripheral or peripherals connected to or connectable to the computer against unauthorized removal. Although computer peripherals and specifically those for desktop use such as mouses and keyboards are generally of a relatively low value compared to the value of a computer, users are often encountered with disappearance of such items from their desks. Even if the items are only borrowed, such situations are still inconvenient for the user.

### SUMMARY OF THE INVENTION

It is an object of the present invention to provide a simple and user-friendly solution for protecting a computer peripheral against unauthorized removal.

According to the present invention, this object is achieved by providing a device according to claim 1. The invention further provides a method according to claim 10 to achieve this object.

By holding the computer peripheral by its signal cord it can be protected against unauthorized removal in a simple manner and since the housing of the peripheral is not directly engaged, the proposed solution does not require the presence of protecting structures attached to the peripheral which would interfere with the ease of use and the freedom of movement of the computer peripheral and would clutter up the desktop environment. Many desktop computer peripherals are directly connected to the signal cord, so that removal of the peripheral is made quite difficult if the signal cord cannot be removed without disconnecting it from the peripheral. Even if the peripheral is connected to the signal cord by an easily releasable connector, it is still not convenient to take away the peripheral if the signal cord cannot be removed, because, lacking the associated signal cord, it would not be readily useable at another desktop.

Particular embodiments of the invention are set forth in the dependent claims.

Further features, effects and details of the invention are described with reference to examples of the devices and methods according to the invention including those appearing from the drawings.

### BRIEF DESCRIPTION OF THE DRAWINGS

FIG. 1 is a perspective view of a first example of device according to the invention incorporated in a desktop support for a notebook computer;

FIG. 2 is another perspective view, obliquely from the rear, of the device according to FIG. 1;

FIG. 3 is an enlarged view of a bottom part of the device according to FIGS. 1 and 2;

FIG. 4 is a further enlarged cut-away view of the bottom part according to FIG. 3;

FIG. 5 is a perspective view of a second example of a device according to the invention and further shows, in schematic representation, a desk, a computer and computer peripherals;

FIG. 6 is a perspective view of the device according to FIG. 5 in open condition;

FIG. 7 is a top plan view of a third example of a device according to the invention;

FIG. 8 is a view in cross-section along the line VIII-VIII in FIG. 7; and

FIG. 9 is a perspective view of a fourth example of a device according to the invention.

### DETAILED DESCRIPTION

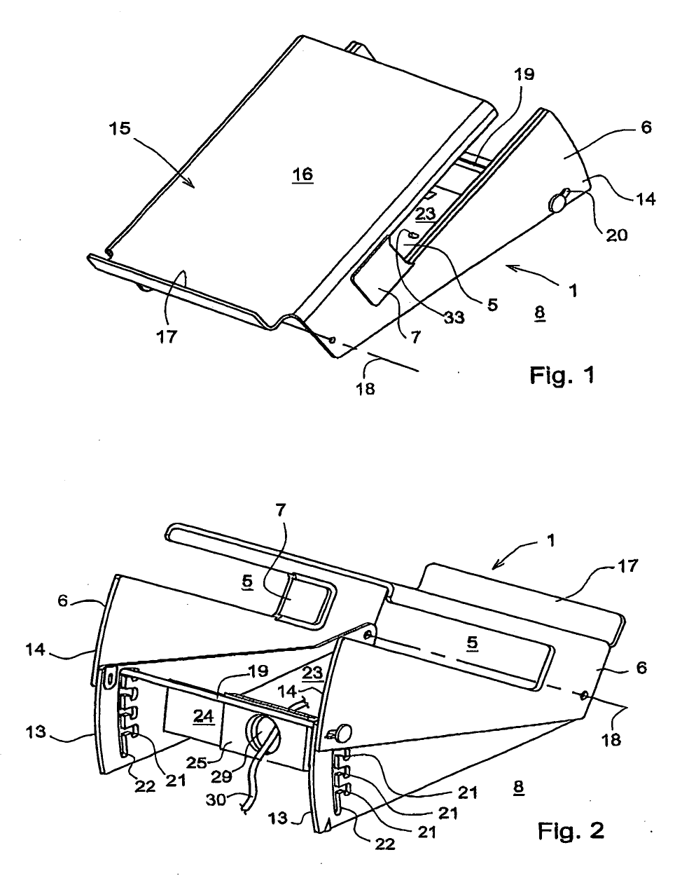

First, the exemplary embodiment shown in FIGS. 1-4 is described.

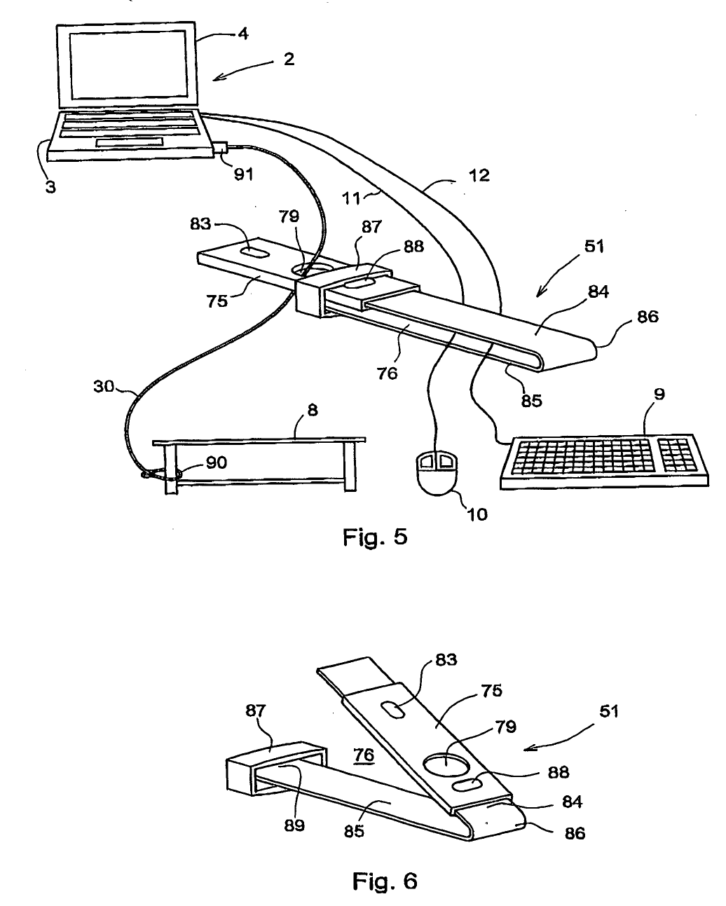

A support for a laptop or notebook computer (for instance as schematically shown in FIG. 5) is designated by reference numeral 1. The support 1 is intended for receiving a portable computer 2 with a keyboard 3 and a display flap 4 pivotably mounted to the keyboard 3. For supporting the keyboard portion 3, the support 1 is provided with a support structure in the form of slots 5 in sidewalls 6 of the support 1, which slots 5 are upwardly inclined towards the rear and open towards the rear. The depth of the slots 5 is adjustable between various depths by inserting filling pieces 7 into the closed ends of the slots.

The sidewalls 6 form a support structure that, in the operational condition shown, projects downwards from the slot 5, such that the keyboard 3 supported by the edges of the slots 5 is kept at a distance above a surface 8 on which the support 1 stands. Thus, in use, the display flap 4—and hence the display—is located at a distance above the desktop 8. Since the display is located at a distance above the worktop, the risk of neck complaints during working with the computer for a longer time, is limited. The computer 2 can be operated by means of control members in the form of a separate keyboard 9 and a mouse 10, connected to the computer 2 via signal cords 11, 12 (see FIG. 5). More details regarding the use of such a notebook or laptop support are described in commonly assigned international patent application WO02/06937.

The support 1 further comprises a document support 15 with a support surface 16 that extends above and along the slot 5. If a keyboard of a computer is positioned in the slots 5, a portion of the keyboard 3 located adjacent the display flap 4 projects from below the document support 15 and the display flap 4 projects upwards behind the document support 15. The document support 15 enables supporting documents in a position above the keyboard portion 3 of the computer 2 and tilted and elevated above the desktop 8.

Along the lower edge of the document support 15, a support edge 17 projects upwards. In use, this support edge 17 bounds a lower end of the document support surface which projects forward relative to the slots 5 in the support to provide sufficient space between the edge 17 and a display 4 for documents of usual height such as A4 (297 mm), Letter (11 inch) or Legal (14 inch).

The sidewalls 6 of the support are each composed of two panels 13, 14 that are pivotable relative to each other about an axis 18. The upper ones 14 of the panels 13, 14 can be retained in various positions by positioning a rod 19, which is laterally shiftable in slots 20 in the upper panels 14, in one of various recesses 21 communicating with a vertically extending adjustment slot 22.

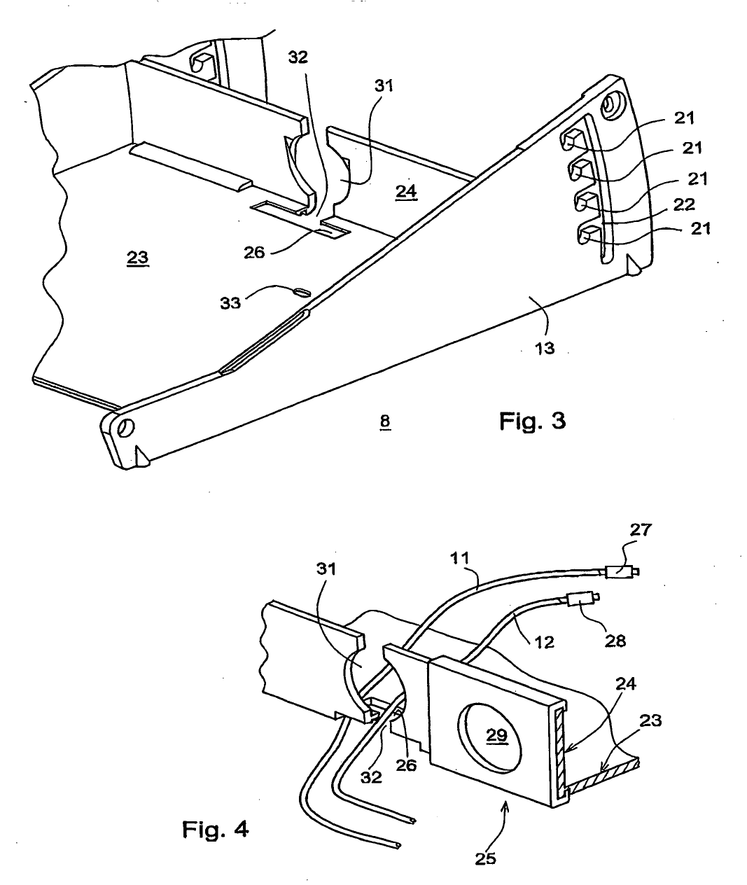

For protecting a computer peripheral, such as the mouse 10, the keyboard 9 shown in FIG. 5 or a power converter, against unauthorized removal, the support 1 is provided with a signal cord holding portion. In this example, a plate 23, a wall 24 and a slide 25 sidable along the wall 24 for the signal cord holding portion. The plate 23 and the wall 24 also form an interconnection between the lower panels 13 of the support plates 6. In FIG. 3, the slide 25 is not shown.

In the plate 23, a signal cord holding passage 26 for receiving a signal cord 11, 12 for operatively connecting a computer peripheral to a computer is arranged. The signal cord holding portion is transformable between an open condition (as shown in FIG. 4) for receiving signal cords 11, 12 in the signal cord holding passage 26 or releasing signal cords 11, 12 from the signal cord holding passage 26 and a signal cord holding condition (shown in FIG. 2) for preventing removal of the signal cords 11, 12 from the signal cord holding passage 26 without dismounting the signal cord from a connector 27, 28 connected to the signal cord, which connector 27, 28 has a substantially larger cross-section than the signal cord 11, 12. Most connectors have a smallest cross-sectional size of more than 10 mm, so that a largest width of the signal cord holding passage of 10 mm or less when the signal cord holding portion is in its signal cord holding condition will protect most signal cords form being removed from the passage. However, some connectors, such as USB plugs, have a cross-sectional size of about 7 mm, so that a smallest cross-sectional dimension of the signal cord holding passage of at most 6 mm and preferably at most 5 mm will allow to protect an even wider range of types of signal cords from being removed and still be large enough to accommodate most signal cords usually employed in a desktop environment. To allow also the thickest cables that are commonly employed, the smallest dimension of the signal cord holding passage preferably measures at least 8 mm. If only thinner cables need to be accommodated, the smallest dimension of the signal cord holding passage may also measure at least 5 to 6 mm.

The slide 25 forms a connecting structure for connecting the support 1 to an object, in this example formed by the cable 30. To this end, the slide 25 has a connecting passage 29 through which the cable 30 or a chain can be guided. The signal cord 29 can be connected to a lock, for instance a cable lock. In turn, the cable 30 can be secured to an item that is fixed or difficult to remove, such as a large piece of furniture, by a lock or by a permanent connection.

The signal cord holding portion and the connecting structure are interconnected for securing the signal cord holding portion in the signal cord holding condition when the connecting structure is connected to the cable 30. In the present example, this is achieved by positioning the connecting passage 29 in such a position relative to a securing bay 31 that the connecting passage 29 and the securing bay 31 are at least partially in-line when the slide 25 blocks an access passage 32 via which signal cords 11, 12 can be passed laterally into and out of the signal cord holding passage 26. If it is attempted to slide the slide 25 to a position in which the passage 32 is open while the cable 30 extends through the connecting passage 29 and the securing bay 31, the cable 30 prevents the slide from moving to a position in which the connecting passage 29 and the securing bay 31 are not at least partially in-line with each other. Since such a position cannot be reached, the slide cannot be slid far enough to open the passage 32 for allowing lateral removal of the signal cords 11, 12 from the signal cord holding passage 32.

Since the connecting passage 29 can only accommodate the cable 30 while the slide 25 is in such a position that it closes off the access passage 32 communicating with the signal cord holding passage 26, the connecting cable 30 can only be guided through the connecting passage 29 when signal cord holding portion is in the signal cord holding condition and the connecting cable 30 extending through the connecting passage 29 keeps the signal cord holding portion secured in the signal cord holding condition. The wall 24 in effect forms a shutter blocking the connecting passage 29 when the signal cord holding portion is in its open condition.

Since the device for protecting a computer peripheral against unauthorized removal by connection to another item is integrated in a computer support 1, the computer support 1 is also protected against unauthorized removal. The support 1 is further provided with an opening 33 for receiving a locking member of a lock. This allows to also protect the support 1 and the computer peripherals of which signal cords extend through the signal cord holding passage 26 against unauthorized removal when the computer to which the lock can be connected is not available, for instance because the user is out of the office and has taken the computer along.

Since the access passage 32 to the signal cord holding passage 26 is a side access for allowing lateral entry and release of the signal cord when the signal cord holding portion is in open condition, the signal cords 11, 12 can be brought into and out of the signal cord holding passage 26 very quickly and easily, without disconnecting the computer peripheral from the computer.

In the example shown in FIGS. 5 and 6, the device 51 has a signal cord holding portion formed by a pair of legs 84, 85 that are flexibly hinged to each other at a first end 86. The hinge can also be provided in other forms, for instance in the form of hinge portions pivotable about a hinge pin or in the form of hinge portions hooked to each other.

A slide 75 forming the connecting portion is mounted to one of the legs 84 of the signal cord-holding portion and slidable along that leg 84 in longitudinal direction of the leg 84. A bow 87 is mounted to the other one 85 of the legs in a position spaced from the hinge end 86 over a distance larger than the length of the slide 75 and slightly larger than the length of the leg 84 to which the slide 75 is mounted. The bow 87 bounds a slide receiver passage 89 into which the slide 75 can be inserted slidingly along the leg 84 to which it is mounted when that leg 84 is pivoted into an orientation extending closely along the other leg 85. The slide is provided with an abutment 88 projecting beyond the contour of the slide receiver passage 89. When the slide 75 extends through the slide receiver passage 89. this abutment 88 prevents the slide 75 from moving away from the hinge end 86 so far that the slide 75 is removed from the leg 84 and that leg is released.

The slide further includes a connecting passage 79 through which a cable 30 or the like can be guided for connecting the device 51 to an item such as a desk 8 by arranging the signal cord as a loop 90 around a leg of the desk 8. The bow 87 and the leg 84 form a shutter which closes off the connecting passage 79 when the slide 75 is in its position closely adjacent the hinge end 86 and allows the legs 84, 85 to pivot apart form each other for receiving or releasing signal cords 11, 12 in of from a signal cord holding passage 76 bounded by the legs 84, 85. With the legs 84, 85 in this V-shaped position, the signal cord holding passage 76 has an enlarged width that is large enough to allow most plugs (connectors) to pass through the passage 76 for inserting or removing signal cords. Furthermore, since the leg 84 along which the slide 85 is slidable is free from the bow 87, signal cords 11, 12 can also be inserted into and removed from the signal cord holding passage 76 in lateral direction when the signal cord holding portion of the device according to this example is in its open position.

After the signal cords 11, 12 have been positioned in the signal cord holding passage 76, the slide 75 is slid away from the hinge end 86 into a position extending through the slide receiver passage 89 in the bow 87 as shown in FIG. 5. With the slide 75 in this position, the legs 84, 85, do not close off the connecting passage 79, so the cable 30 can be threaded through the connecting passage 79. If the cable 30 is first slung around a structure from which it cannot be removed and passed through a permanent loop at its end, as shown in FIG. 5, connecting the free end of the cable 30 to a computer, for instance by means of the lock 91, results in also securing the device 51 to the item 8.

As long as the cable 30 projects through the connecting passage 79, the slide 75 cannot be slid back through the bow 87 without damaging the device 51, because sliding the slide 75 back requires the connecting passage 79 to move to a position closely in front of the legs 84, 85 and to pass through the bow 87, which is prevented by the presence of the cable 30 projecting through the connecting passage 79. Furthermore, the projection 88 prevents the slide 75 from sliding further away from the hinge end 86. Thus, the slide 75 cannot be displaced to such an extent that the leg 84 is free to pivot away from the other leg 85. In the position shown in FIG. 5, the largest width of the signal cord holding passage 76 is smaller than the smallest cross-sectional size of the connectors connected to the signal cords 11, 12. Furthermore, the stiffness of the device 51 is such that the signal cords 11, 12 cannot be removed from the signal cord holding passage 76 without damaging the device 51.

Also in this example, the device is provided with a slot 83 for engagement by a lock 91, so that the device 51 can also be connected to an item 8 if the computer 2 is not available to receive the operative end of the lock 91.

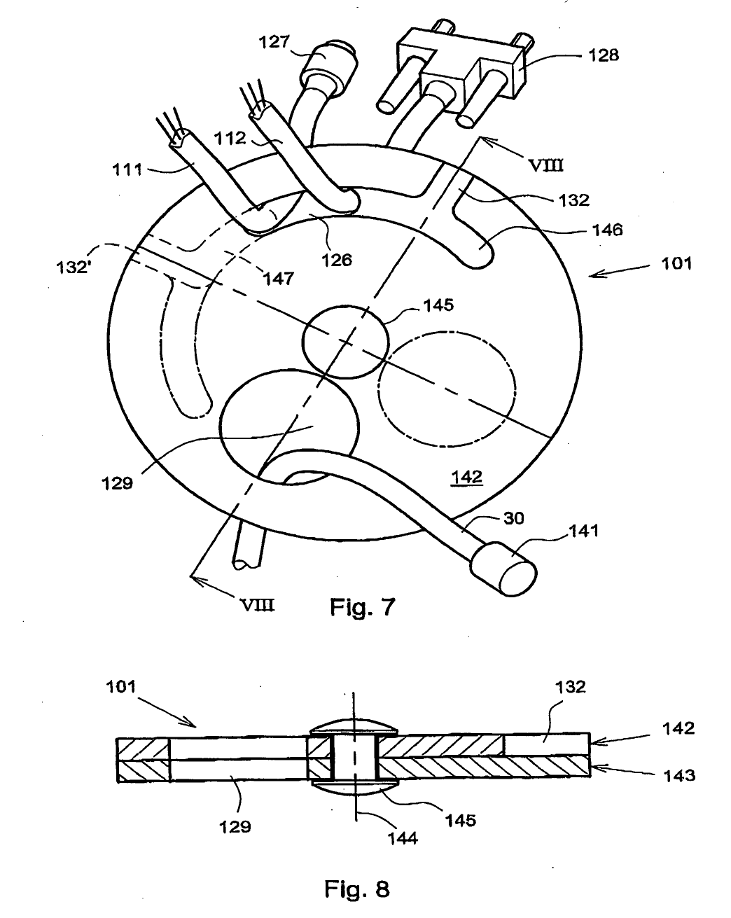

In the example shown in FIGS. 7 and 8, the signal cord holding portion and the connecting portion are integrally connected in the form of portions of a pair of discs 142, 143 rotatable relative to each other about a common axis 144 and interconnected by a pin 145.

In the signal cord holding condition as shown, a signal cord holding passage 126 and a connecting passage 129 extend through the discs 142, 143. The signal cord holding passage 126 is for receiving signal transfer signal cords 111, 112 to be secured to the device 101 and the connecting passage 129 is for receiving a connecting cable 30 for securing the device 101 to an element that is fixed or difficult to displace. The area of mutual overlap between slots 146, 147 in the upper disk and the lower disk forms the signal cord holding passage 126. Apart from access portions 132, 132′, at least portions of the slots 146, 147 extend along a radius about the axis of rotation 145. Accordingly, the effective width of the signal cord holding passage 126 does not vary significantly if the disks 142, 143 are rotated relative to each other. In the signal cord holding condition as shown, the signal cord holding passage 126 has an essentially closed circumference and a width which is too small to allow the plugs 127, 128 to pass there through. This prevents the signal cords 111, 112 from being removed from the signal cord holding passage 126. The size of the connecting passage 129 is such that the lock 141 attached to a free end of the cable 30 can be passed through that passage. To this end, the smallest dimension of the connecting passage 129 is preferably at least 18 to 20 mm and more preferably at least 30 to 35 mm to allow the cable end carrying the lock through the connecting passage 129.

If the disks 142, 143 are rotated relative to each other, the portions of the connecting passage 129 are shifted out of line until edges of the passage in the disks 142, 143 abut against opposite sides of the cable 30. This prevents the disks 142, 143 from being rotated relative to each other to such an extent that the position of the upper disk 142 indicated with dot and dash lines is reached in which position access passages 132, 132′ communicating with the signal cord holding passage 126 are in line with each other and allow signal cords 111, 112 to be laterally inserted into or removed from the signal cord holding passage.

If the lock 141 is released, the cable 30 can be removed from the connecting passage 129. The disks 142, 143 can then be rotated freely relative to each other until the position of the disk 142 indicated in dash and dot lines is reached which allows signal cords to be laterally inserted into or removed from the slots 146, 147.

It is observed that within the framework of the invention many other variants than those described above are conceivable. For instance, the locking of the signal cord holding portion in the signal cord holding condition can also be accomplished by other means than a flexible pulling member extending through a passage. For instance, a lock can be provided which is incorporated in the device according to the invention. Such a lock may include securing means for securing to a fixed item or to an item that is difficult to displace and associated members for preventing signal cords to be released from the device when the securing means are locked or positioned in the condition for securing.

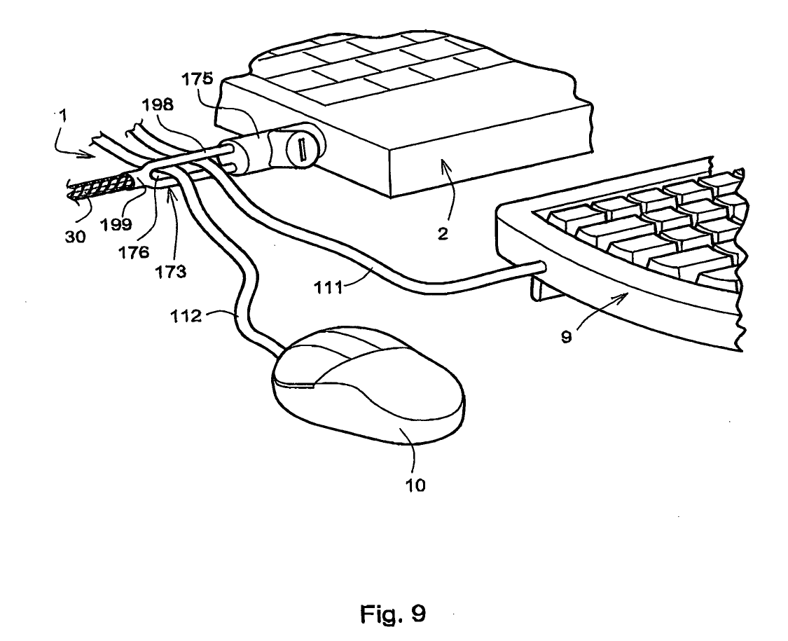

An example of such a variant is shown in FIG. 9. The device 151 according to this example includes a signal cord holding portion in the form of a fork 173 and a connecting structure in the form of a lock 175 for connecting the device to an object, for instance to the computer 2. The fork has a signal cord holding passage 176 for receiving signal cords 111, 112 connected to computer peripherals 9, 10 and to a computer 2. The fork 173 is transformable from an open condition for receiving signal cords 111, 112 or releasing the signal cords 111, 112 to a signal cord holding condition for preventing removal of the signal cords 111, 112 from the fork 173 by inserting the open end of the fork 173 into the lock 175 which then closes off the open interspace 176 between the teeth 198 of the fork 173. In locked condition, the lock 173 retains the teeth 198 of the fork 173 therein and is irremovably connected to a slot in the housing of the computer 2. Thus, in locked condition, the lock 173 can also keep an end of the cable 30 onto which a sleeve 199 of the fork 173 is clamped connected to the computer 2. The other end of the cable can be connected to an item that is at least difficult to remove. When the lock 173 is unlocked, both the fork 173 and the computer 2 are released and can be removed from the lock 173. When the fork 173 has been taken out of the lock, signal cables 111, 112 can be removed from or inserted into the signal cable passage 176 between the teeth 198 of the fork 173. The lock 175 according to this example can be operated in a conventional manner using a key. The lock 175 can for instance contain a rotatable member which includes locking flanges engaging notches in the teeth 198 of the fork 173 and an elongate engagement pawl which can be inserted into a slot of a device when oriented parallel to the elongate cross-section of a stem on the end of which it is located. In turn, a locking cylinder may operate the rotatable member when a key is inserted therein. Alternatively, the lock can also be (numeric) combination lock, a lock operated by a key card, or a lock that is operated remotely, by wire or wireless.

Since the signal cord holding portion 173 is fixedly connected to the cable 30, the number of loose parts, which are inherently prone to being lost, is reduced. A similar effect may also be achieved by fixedly connecting the signal cord holding portion to the lock that can be secured to an object.

1. A device for protecting a computer peripheral against unauthorized removal including:
a signal cord holding portion (23; 84, 85; 173) having a signal cord holding passage (26; 76, 126; 176) for receiving a signal cord (11, 12; 111, 112) for operatively connecting a computer peripheral (9, 10) to a computer (2), the signal cord holding portion (23; 84, 85; 173) being transformable between an open condition for receiving the signal cord (11, 12; 111, 112) in the signal cord holding passage (26; 76, 126; 176) or releasing the signal cord (11, 12; 111, 112) from the signal cord holding passage (26; 76, 126; 176) and a signal cord holding condition for preventing removal of the signal cord (11, 12; 111, 112) from the signal cord holding passage (26; 76, 126; 176) without dismounting the signal cord (11, 12; 111, 112) from a connector or computer peripheral (9, 10, 27, 28; 127, 128) connected to the signal cord (11, 12; 111, 112), which connector or computer peripheral (9, 10, 27, 28; 127, 128) has a substantially larger cross-section than the signal cord (11, 12; 111, 112); and
a connecting structure (25; 75; 142, 143; 175) for securing the device to an object (2; 30); the signal cord holding portion (23; 84, 85; 173) and the connecting structure (25; 75; 142, 143; 175) being interconnected for selectively securing the signal cord holding portion (23; 84, 85; 173) in the signal cord holding condition if the connecting structure (25; 75; 142, 143; 175) is secured to an object (2; 30).

2. A device according to claim 1, wherein the connecting structure (25; 75; 142, 143) includes a connecting passage (29; 79; 129) and a shutter (24; 84, 85, 87; 142, 143), the shutter being connected to the signal cord holding portion (23; 84, 85) for blocking the connecting passage (29; 79; 129) when the signal cord holding portion (23; 84, 85) is in its open condition.

3. A device according to claim 2, wherein the shutter (24; 84, 85, 97; 142, 143) is slidably moveable relative to the connecting passage (29; 79; 129).

4. A device according to claim 3, further comprising a flexible pulling member (30) and a locking member (91; 141) connected to the flexible pulling member (30), the flexible pulling member (30) locking the signal cord holding portion (23; 84, 85) in its signal cord holding condition when extending through the connecting passage (29; 79; 129).

5. A device according to claim 1, wherein the signal cord holding passage (26; 76, 126; 176) has an access passage (32; 132, 132′) for allowing lateral entry and release of the signal cord (11, 12; 111, 112) when the signal cord holding portion (23; 84, 85; 173) is in open condition, the access passage (32; 132, 132′) being closed when the signal cord holding portion (23; 84, 85;173) is in the signal cord holding condition.

6. A device according to claim 1, wherein the signal cord holding passage (26; 76, 126) has a cross section of which at least one dimension is reversibly enlargeable from a largest width for preventing the passage of the connector (27, 28; 127, 128) connected to the signal cord (11, 12; 111, 112) when the signal cord holding portion (23; 84, 85) is in the signal cord holding condition to an enlarged dimension for allowing the connector (27, 28; 127, 128) connected to the signal cord (11, 12; 111, 112) to pass through the signal cord holding passage (26; 76, 126), when the signal cord holding portion (23; 84, 85) is in open condition.

7. A device according to claim 1, further including an opening (33; 83) for receiving a locking member of a lock (91; 141).

8. A device according to claim 1, further comprising:
a support structure (1) for supporting at least a portion of a keyboard portion (3) of a portable computer (2) in a position at least partially spaced from a desktop (8), and a bearing structure (6) which, in operational condition, projects downwards from said support structure such that at least a portion of said support structure-supported keyboard portion (3) located adjacent a display panel (4) is kept at a distance above a face (8) on which the support structure (1) stands.

9. A device according to claim 1, wherein the signal cord holding portion (173) is fixedly connected to at least one part of the connecting structure (175).

10. A method for protecting a computer peripheral against unauthorized removal, comprising:
providing a signal cord holding device (1; 51; 101; 151);
operating the signal cord holding device (1; 51; 101; 151) to hold a signal cord (11, 12; 111, 112; 151) of the computer peripheral (9, 10);
connecting the signal cord holding device to an object (2; 8; 30); and
protecting the device (1; 51; 101; 151) and the connection against unauthorized release.

11. A method according to claim 12, wherein the signal cord holding device (1; 51; 101; 151) and a computer (2) are connected to said object (8) by a common connecting member (30).

12. A method according to claim 11, wherein the computer (2) and the signal cord holding device (1; 51; 101; 151) are connected to a flexible pulling member (30) and a lock (91; 141; 175).

13. A method according to claim 12, wherein the signal cord holding device (1; 51; 101) is locked in signal cord holding condition by the flexible pulling member (30).
